(19) United States
(12) Patent Application Publication
(10) Pub. No.: US 2026/0219447 A1
(43) Pub. Date: Jul. 30, 2026

(54) OPTICAL WAVEGUIDE DEVICE

(71) Applicant: SUMITOMO ELECTRIC INDUSTRIES, LTD., Osaka-shi, Osaka (JP)

(72) Inventors: Tetsuya NAKANISHI, Osaka-shi (JP); Hajime ARAO, Osaka-shi (JP); Yoshihiro TSUKUDA, Osaka-shi (JP); Manabu SHIOZAKI, Osaka-shi (JP)

(73) Assignee: SUMITOMO ELECTRIC INDUSTRIES, LTD., Osaka-shi, Osaka (JP)

(21) Appl. No.: 19/145,562

(22) PCT Filed: Jan. 12, 2024
(86) PCT No.: PCT/JP2024/000705

§ 371 Date: Jul. 3, 2025

(30) Foreign Application Priority Data
Jan. 16, 2023 (JP) 2023-004505

(51) Int. Cl. G02B 6/122; G02B 6/12

(52) U.S. Cl. CPC G02B 6/1223; G02B 2006/12038

(57) ABSTRACT

This optical waveguide device comprises a substrate made of glass having a uniform composition ratio. The substrate includes a base material portion and a refractive index changing portion. The refractive index changing portion has a refractive index different from the refractive index of the base material portion. The refractive index changing portion includes at least a pair of a refractive index decreasing portion and a refractive index increasing portion. The refractive index of the refractive index increasing portion is higher than the refractive index of the refractive index decreasing portion. The distance between the boundary between the refractive index decreasing portion and the refractive index increasing portion and a portion of the refractive index increasing portion where the intensity of propagating light is maximum is 5 μm or more.

### TECHNICAL FIELD

The present disclosure relates to an optical waveguide device. This application claims priority from Japanese Patent Application No. 2023-004505 filed on Jan. 16, 2023, and the entire contents of the Japanese patent application are incorporated herein by reference.

### BACKGROUND ART

A substrate constituted by glass and including a base portion and a refractive-index change portion is known (for example, non-patent literature 1 and non-patent literature 2). A refractive-index change portion has a refractive index differing from a refractive index of the base portion.

### CITATION LIST

### Non Patent Literature

Non-patent literature 1: Nov. 1, 1996, Vol. 21, No. 21, OPTICS LETTERS, pp 1729
Non-Patent literature 2: Y. Nasu, Yusuke “Low-Loss Waveguides Written with a Femtosecond Laser for Flexible Interconnection in a Planar Light-Wave Circuit” Optics Letters 30, no. 7 (2005)

### SUMMARY OF INVENTION

An optical waveguide device according to an embodiment of the present disclosure includes a substrate constituted by glass having a uniform composition ratio. The substrate includes a base portion and a refractive-index change portion. A refractive-index change portion has a refractive index differing from a refractive index of the base portion. The refractive-index change portion includes at least a pair of a refractive-index decrease portion and a refractive-index increase portion. A refractive index of the refractive-index increase portion is higher than a refractive index of the refractive-index decrease portion. A distance from a boundary between the refractive-index decrease portion and the refractive-index increase portion to a portion in which intensity of propagating light is at its maximum in the refractive-index increase portion is 5 μm or more.

An optical waveguide device according to an embodiment of the present disclosure includes a substrate constituted by glass having a uniform composition ratio. The substrate includes a base portion and a refractive-index change portion. A refractive-index change portion has a refractive index differing from a refractive index of the base portion. The refractive-index change portion includes at least a pair of a refractive-index decrease portion and a refractive-index increase portion. A refractive index of the refractive-index increase portion is higher than a refractive index of the refractive-index decrease portion. A value obtained by dividing a distance from a boundary between the refractive-index decrease portion and the refractive-index increase portion to a portion in which intensity of propagating light is at its maximum in the refractive-index increase portion by a maximum width of light propagating through the refractive-index increase portion is 0.5 or more.

### BRIEF DESCRIPTION OF THE DRAWINGS

FIG. 1 is a perspective view schematically showing an optical waveguide device according to an embodiment.

FIG. 2 is a perspective view schematically showing the state of irradiation of a substrate with laser light.

FIG. 3 is a cross-sectional view schematically showing the state of irradiation with laser light in the substrate.

FIG. 4 is a diagram showing a state in which a refractive-index change portion is formed on a substrate.

FIG. 5 is a diagram schematically showing the relationship between the width of the refractive-index change portion and the refractive index.

FIG. 6 is a diagram showing the position of the outer edge of the refractive-index increase portion in the substrate.

FIG. 7 is a diagram showing the relationship between the position of the refractive-index increase portion and the relative refractive index difference.

FIG. 8 is a graph showing a relationship between the change amount of the position of the outer edge of the refractive-index change portion and the transmission loss of light propagating through the refractive-index change portion.

FIG. 9 is a graph showing a relationship among a change amount of a position of an outer edge of a refractive-index change portion, a standard deviation dΔ of a relative refractive index difference Δ of the refractive-index change portion, and a transmission loss of light propagating through the refractive-index change portion.

FIG. 10 is a graph indicating a refractive index change on a line passing through the refractive-index decrease portion and the refractive-index increase portion and orthogonal to the main surface.

FIG. 11 is a schematic diagram showing a light optical system for observing a portion in which intensity of propagating light is at its maximum in the refractive-index increase portion.

FIG. 12 is a diagram showing an image including a portion in which intensity of propagating light is at its maximum in the refractive-index increase portion.

FIG. 13 is a diagram showing an image including a refractive-index change portion formed on a glass substrate.

FIG. 14 is a diagram showing an image obtained by superimposing an image including a portion in which intensity of propagating light is at its maximum in the refractive-index increase portion and an image including a refractive-index change portion formed on a glass substrate.

FIG. 15 is a graph showing optical loss with respect to a distance from a boundary between a refractive-index decrease portion and a refractive-index increase portion to a portion in which intensity of propagating light is at its maximum in the refractive-index increase portion.

### DETAILED DESCRIPTION

### Problems to be Solved by the Present Disclosure

By irradiating a glass substrate constituted by glass with pulsed laser light having peak power, a density change occurs in the glass substrate. For example, a femtosecond laser is irradiated to the glass substrate. As a result, a refractive-index change portion is formed in the glass substrate. The refractive-index change portion constitutes an optical waveguide. That is, the optical waveguide is formed in the glass substrate by irradiating the glass substrate with laser light. As described above, in the configuration in which the refractive-index change portion is formed in the glass substrate, a method of setting the optical loss to be 0.1 dB/cm or less has not been established. For example, when the refractive-index change portion is formed of a continuous body, light scattering is likely to occur, and optical loss may also decrease.

The present disclosure provides an optical waveguide device in which optical loss is reduced in a configuration in which a refractive-index change portion is formed on a glass substrate.

### Advantageous Effects of Present Disclosure

According to the present disclosure, an optical waveguide device in which optical loss is reduced in a configuration in which a refractive-index change portion is formed on a glass substrate can be provided.

### Description of Embodiments of Present Disclosure

First, the contents of embodiments of the present disclosure will be described by listing them individually.

(1) An optical waveguide device according to an embodiment of the present disclosure includes a substrate constituted by glass having a uniform composition ratio. The substrate includes a base portion and a refractive-index change portion. A refractive-index change portion has a refractive index differing from a refractive index of the base portion. The refractive-index change portion includes at least a pair of a refractive-index decrease portion and a refractive-index increase portion. A refractive index of the refractive-index increase portion is higher than a refractive index of the refractive-index decrease portion. A distance from a boundary between the refractive-index decrease portion and the refractive-index increase portion to a portion in which intensity of propagating light is at its maximum in the refractive-index increase portion is 5 μm or more.

The inventors of the present application have found that the optical loss increases when the distance from the boundary between the refractive-index decrease portion and the refractive-index increase portion to a portion in which intensity of propagating light is at its maximum in the refractive-index increase portion is short. In the optical waveguide device, the distance from the boundary between the refractive-index decrease portion and the refractive-index increase portion to a portion in which intensity of propagating light is at its maximum in the refractive-index increase portion is 5 μm or more. In this case, optical loss is reduced in a configuration in which the refractive-index change portion is formed in the glass substrate.

(2) In the optical waveguide device according to (1), a value obtained by dividing the distance by a maximum width of light propagating through the refractive-index increase portion may be 0.5 or more. The degree of confinement of the propagating light in the refractive-index increase portion is also considered to be related to the optical loss. According to this configuration, the optical loss is more reliably reduced.

(3) In the optical waveguide device according to (1) or (2), the substrate may contain 10 wt % or more of silicon dioxide. In this case, a bandgap in the base portion may be 3.5 eV or more. In this case, a structure in which the refractive-index decrease portion is more precisely formed, is provided. In glass containing a certain amount or more of silicon dioxide, the glass transition temperature is generally 700° C. or higher, and the melting range is limited to submicron or less even after the energy of laser light is converted into heat through electron-phonon relaxation. Thus, the reduction of light scattering by the refractive-index decrease portion and the formation of the optical waveguide are more precisely controlled.

(4) An optical waveguide device according to an embodiment of the present disclosure includes a substrate constituted by glass having a uniform composition ratio. The substrate includes a base portion and a refractive-index change portion. A refractive-index change portion has a refractive index differing from a refractive index of the base portion. The refractive-index change portion includes at least a pair of a refractive-index decrease portion and a refractive-index increase portion. A refractive index of the refractive-index increase portion is higher than a refractive index of the refractive-index decrease portion. A value obtained by dividing a distance to a portion in which intensity of propagating light is at its maximum in the refractive-index increase portion by a maximum width of light propagating through the refractive-index increase portion is 0.5 or more.

The inventors of the present application have found that the optical loss increases when the distance from the boundary between the refractive-index decrease portion and the refractive-index increase portion to the center of the propagating light propagating through the refractive-index increase portion is short. Further, the degree of confinement of the propagating light in the refractive-index increase portion is also considered to be related to the optical loss. In the optical waveguide device, a value obtained by dividing the distance to the portion in which intensity of propagating light is at its maximum in the refractive-index increase portion by the maximum width of light propagating through the refractive-index increase portion is 0.5 or more. In this case, optical loss is reduced in a configuration in which the refractive-index change portion is formed in the glass substrate.

(5) In the optical waveguide device according to an embodiment of the present disclosure, the substrate may contain 10 wt % or more of silicon dioxide. In this case, a bandgap in the base portion may be 3.5 eV or more. In this case, a structure in which the refractive-index decrease portion is more precisely formed, is provided. In glass containing a certain amount or more of silicon dioxide, the glass transition temperature is generally 700° C. or higher, and the melting range is limited to submicron or less even after the energy of laser light is converted into heat through electron-phonon relaxation. Thus, the reduction of light scattering by the refractive-index decrease portion and the formation of the optical waveguide are more precisely controlled.

(6) In the optical waveguide device according to the above (1) to (5), the substrate may have a main surface. In the pair of the refractive-index decrease portion and the refractive-index increase portion, the refractive-index decrease portion may be located between a portion of the refractive-index increase portion and the main surface. The boundary between the refractive-index decrease portion and the refractive-index increase portion may include an inflection point of a curved line indicating a refractive index change on a line passing through the refractive-index decrease portion and the refractive-index increase portion and orthogonal to the main surface. In this case, the optical loss is further reduced.

(7) In the optical waveguide device according to the above (1) to (6), the substrate may have a main surface. In the pair of the refractive-index decrease portion and the refractive-index increase portion, the refractive-index decrease portion may be located between a portion of the refractive-index increase portion and the main surface. A value obtained by dividing a width of the refractive-index increase portion in a direction orthogonal to the main surface by a maximum width of light propagating through the refractive-index increase portion may be 0.6 to 2. The longer the width of the refractive-index increase portion in the direction orthogonal to the main surface, the longer the distance is likely to be constituted. When the width of the refractive-index increase portion in the direction orthogonal to the main surface is too long, a high-order mode may occur. According to the above configuration, the width of the refractive-index increase portion in the direction orthogonal to the main surface is balanced, and the optical loss is further reduced.

(8) In the optical waveguide device according to the above (1) to (7), the substrate may have a main surface. In the pair of the refractive-index decrease portion and the refractive-index increase portion, the refractive-index decrease portion may be located between a portion of the refractive-index increase portion and the main surface. The refractive-index change portion may extend in a first direction along the main surface. A change amount of a position of an outer edge of the refractive-index increase portion in a second direction may be 0.12 μm or less. The second direction is along the main surface and orthogonal to the first direction. When the change amount of the position of the outer edge of the refractive-index increase portion in the second direction is large, the scattering loss may increase. According to the above configuration, the optical loss is further reduced.

(9) In the optical waveguide device according to the above (1) to (8), the substrate may have a main surface. In the pair of the refractive-index decrease portion and the refractive-index increase portion, the refractive-index decrease portion may be located between a portion of the refractive-index increase portion and the main surface. The refractive-index change portion may extend in a first direction along the main surface. When a change amount of a position of an outer edge of the refractive-index increase portion in a second direction is σ [μm], and a change amount of a relative refractive index difference of the refractive-index increase portion in the second direction is dΔ [%], 0.1×((σ/0.13745)\hat{ }2+(dΔ/0.00677)\hat{ }2)<0.1 [dB/cm] may be satisfied. The second direction is along the main surface and orthogonal to the first direction. In this case, the optical loss is further reduced.

(10) In the optical waveguide device according to the above (1) to (8), the substrate may have a main surface. In the pair of the refractive-index decrease portion and the refractive-index increase portion, the refractive-index decrease portion may be located between a portion of the refractive-index increase portion and the main surface. The substrate may include a plurality of the refractive-index change portions spaced apart from each other and extending along the main surface. In the substrate, a plurality of cores in each of which the relative refractive index difference of the refractive-index increase portion is 0.2% or more may be formed by each of the plurality of refractive-index change portions. When the distance between the plurality of cores may be 20 μm to 40 μm and propagating light in the plurality of refractive-index change portions has a wavelength of 1310 nm to 1550 nm, crosstalk between the plurality of refractive-index change portions may be −30 dB or less. In this case, even when a plurality of cores are formed, optical loss is reduced.

### Details of Embodiments of Present Disclosure

Specific examples of embodiments of the present disclosure will be described below with reference to the drawings. The present disclosure is not limited to these examples, but is defined by the scope of the claims, and is intended to include all modifications within the meaning and scope equivalent to the scope of the claims. In the description of the drawings, the same elements are denoted by the same reference numerals, and redundant description will be omitted.

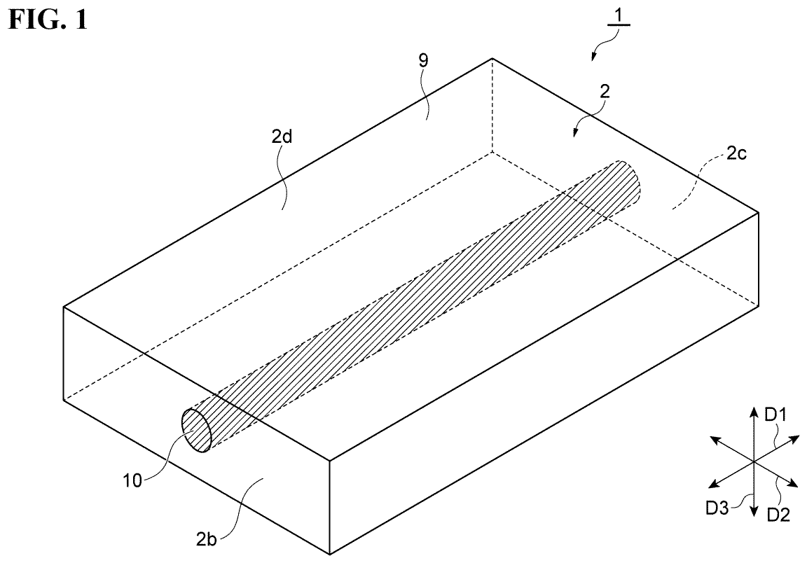

FIG. 1 is a perspective view schematically showing an optical waveguide according to an embodiment. An optical waveguide device 1 includes a substrate 2 constituted by glass. For example, the substrate 2 is constituted by a single layer having the same composition and the same composition ratio. The substrate 2 includes a base portion 9 and a refractive-index change portion 10 formed inside the substrate 2. In the optical waveguide device 1, the refractive-index change portion 10 corresponds to a portion through which light propagates. The substrate 2 extends in, for example, a direction D1 and a direction D2 intersecting the direction D1. The substrate 2 has a thickness in a direction D3 intersecting with both the direction D1 and the direction D2. As an example, the direction D1 is the longitudinal direction of the substrate 2. The direction D1, the direction D2, and the direction D3 are, for example, orthogonal to each other. The direction D1 corresponds to a first direction, the direction D2 corresponds to a second direction, and the direction D3 corresponds to a third direction.

The substrate 2 is constituted by glass having a uniform composition ratio. In this specification, “uniform” includes being substantially uniform. The expression “having a uniform composition ratio” means that the variation in the composition ratio of glass between the region where the waveguide is formed and the periphery of the waveguide is 3% or less. The substrate 2 has, for example, a rectangular plate shape. The substrate 2 has, for example, a first end surface 2b on which an end surface of the refractive-index change portion 10 is exposed and a second end surface 2c facing opposite to the first end surface 2b. The refractive-index change portion 10 is covered by the base portion 9 except for the first end surface 2b and the second end surface 2c. The substrate 2 contains 10 wt % or more of silicon dioxide (SiO₂), and the bandgap in the base portion 9 is 3.5 eV or more. For example, the substrate 2 is constituted by glass containing 80 wt % or more of SiO₂. Further, the substrate 2 may be constituted by glass containing 95 wt % or more of SiO₂. Examples of the glass used for the substrate 2 include fused silica, fused silica containing a minute additive, Borosilicate glass, and aluminosilicate glass.

The substrate 2 contains an OH group. For example, the concentration of the OH group contained in the substrate 2 is 100 [wtppm] or less. The substrate 2 may be constituted by SiO₂ to which deuterium is added. Further, the substrate 2 may be constituted by SiO₂ containing halogen at a concentration of 0.5 [wt %] or more. The refractive-index change portion 10 has a refractive index differing from a refractive index of the base portion 9. The refractive-index change portion 10 is a portion in which the density of glass is changed with respect to the base portion 9. The refractive-index change portion 10 extends along the direction D1 inside the substrate 2. In an embodiment, the direction D1 corresponds to a longitudinal direction of the refractive-index change portion 10.

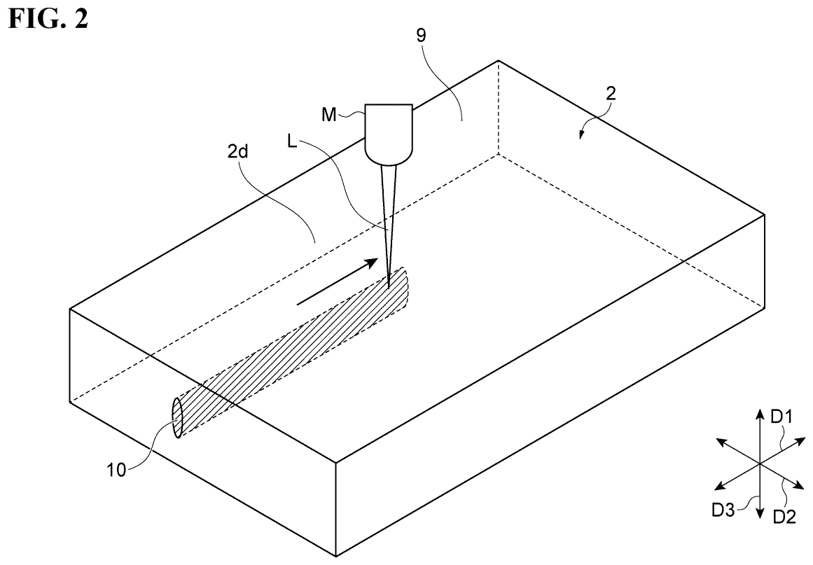

Next, a specific example of a manufacturing method of the optical waveguide device 1 according to the embodiment will be described. As shown in FIG. 2, the glass constituting the substrate 2 is irradiated with femtosecond laser light L. The manufacturing method of the optical waveguide device 1 includes a first step of forming the refractive-index change portion 10 and a second step of reducing the variation in the refractive index of the glass of the refractive-index change portion 10.

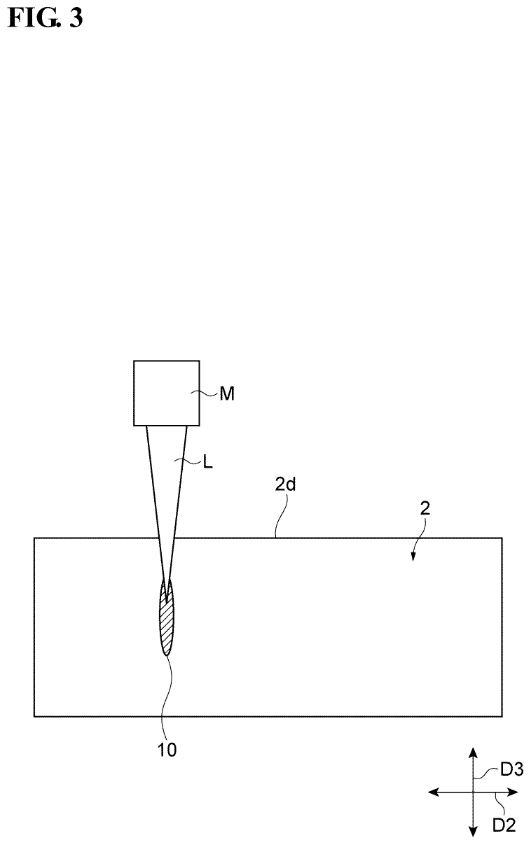

FIG. 2 is a perspective view showing irradiation of the substrate 2 with the femtosecond laser light L in the first step. FIG. 3 is a cross-sectional view showing the irradiation with the femtosecond laser light L in the substrate 2 in the first step. As shown in FIG. 2 and FIG. 3, in the first step, an irradiation device M for radiating the femtosecond laser light Lis moved along the direction D1 to irradiate the substrate 2 with the femtosecond laser light L. The pulse width of the femtosecond laser light L in the first step is 300 [fs] or less. The repetition frequency of the femtosecond laser light L in the first step is 700 [KHz] or less.

The substrate 2 has a main surface 2d extending in the direction D1 and the direction D2, and for example, the irradiation device M irradiates the main surface 2d with the femtosecond laser light L. The femtosecond laser light Lis radiated from the irradiation device M along direction D3 towards the substrate 2.

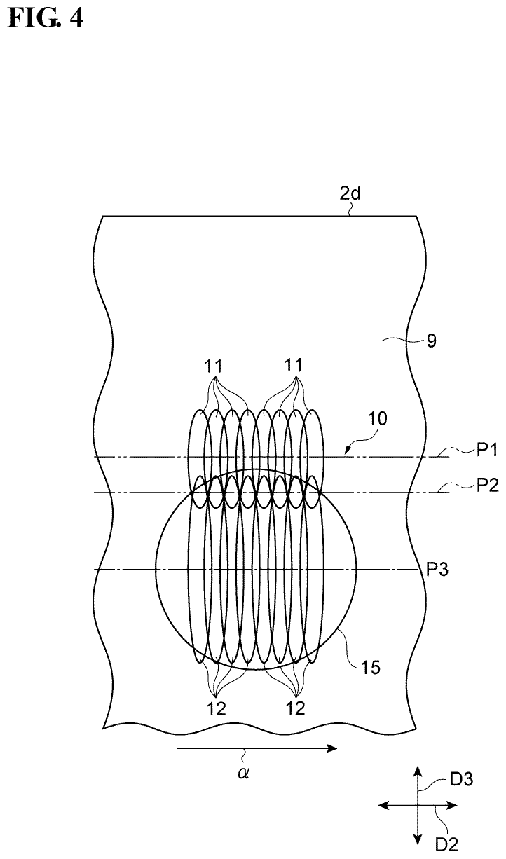

As shown in FIG. 4, the refractive-index change portion 10 formed in the first step includes at least a pair of a refractive-index increase portion 12 and a refractive-index decrease portion 11. FIG. 4 is a view showing a state in which a refractive-index change portion is formed on a substrate. The refractive index of the refractive-index increase portion 12 is higher than the refractive index of the refractive-index decrease portion 11. The refractive index of the refractive-index decrease portion 11 includes a portion in which the refractive index is lower than the refractive index of the base portion 9. The refractive index of the refractive-index increase portion 12 is higher than the refractive index of the base portion 9. The refractive-index decrease portion 11 is formed between the main surface 2d of the substrate 2 and the refractive-index increase portion 12. The refractive-index decrease portion 11 is formed, for example, at a light convergence position P1 of the femtosecond laser light L in the first step. The refractive-index change portion 10 includes a boundary P2 between the refractive-index decrease portion 11 and the refractive-index increase portion 12.

The femtosecond laser light L is radiated while the irradiation device Mis moved along the direction D1, and thus the refractive-index increase portion 12 and the refractive-index decrease portion 11 extending in the direction D1 are formed in the substrate 2. The cross section of the refractive-index increase portion 12 in a plane orthogonal to the direction D1 has, for example, an elliptical shape having a major axis in the direction D3. The cross section of the refractive-index decrease portion 11 in the plane orthogonal to the direction D1 has, for example, an elliptical shape having a major axis in the direction D3.

As shown in FIG. 4, in the first step, the plurality of refractive-index increase portions 12 and the plurality of refractive-index decrease portions 11 are formed while shifting the positions in a direction α. The plurality of refractive-index increase portions 12 arranged along the direction D2 overlap each other. Similarly, the plurality of refractive-index decrease portions 11 arranged along the direction D2 overlap each other. In this way, the plurality of refractive-index increase portions 12 overlapping each other along the direction D2 are formed, and thus the plurality of refractive-index increase portions 12 forming a rectangular shape are formed in the first step.

In the second step, the plurality of refractive-index increase portions 12 formed in the first step are irradiated with the femtosecond laser light L. The pulse width of the femtosecond laser light L in the second step is 300 [fs] or less. The repetition frequency of the femtosecond laser light L in the second step is higher than 700 [kHz]. The pulse width of the femtosecond laser light L in the second step is, for example, the same as the pulse width of the femtosecond laser light L in the first step. In this case, the irradiation with the femtosecond laser light L in the second step can be easily performed.

The repetition frequency of the femtosecond laser light L in the second step is higher than the repetition frequency of the femtosecond laser light L in the first step. When the pulse peak power of the femtosecond laser light L radiated in the first step is PW1 and the pulse peak power of the femtosecond laser light L radiated in the second step is PW2, PW1 is larger than PW2. The PW2 is larger than (PW1/100).

In the irradiation with the femtosecond laser light L in the second step, a reducing portion 15 of the refractive index is formed so as to surround the plurality of refractive-index increase portions 12. The depth of a light convergence position P3 of the femtosecond laser light L in the second step (the depth from the main surface 2d) is deeper than the depth of the light convergence position P1 of the femtosecond laser light L in the first step. Thus, in the optical waveguide device 1, the reducing portion 15 is formed so as to surround the plurality of refractive-index increase portions 12 located below the plurality of refractive-index decrease portions 11 (downstream in the traveling direction of the femtosecond laser light L). In the second step, for example, irradiation with the femtosecond laser light L is performed once. In this case, in the second step, the irradiation with the femtosecond laser light L is performed once while the irradiation device Mis moved along the direction D1. The refractive-index increase portion 12 is a portion having a higher refractive index than the portion (cladding) of the substrate 2 other than the refractive-index increase portion 12. The reducing portion 15 is a portion in which the refractive index gradually changes from the refractive-index increase portion 12 toward the cladding. The refractive-index change portion 10 includes the plurality of refractive-index increase portions 12 and a plurality of refractive-index reducing portions 15.

The plurality of refractive-index increase portions 12 include a waveguide portion having a refractive index larger than the refractive index of the substrate 2 by 0.01% or more. The waveguide portion indicates a region having a refractive index larger than the refractive index of the substrate 2 by 0.01% or more in the cross section of the plurality of refractive-index increase portions 12. When the cross-sectional area of the waveguide portion is S and the standard deviation of (S/π)^{1/2} in a longitudinal direction is σR, a centroid coordinates G (D2, D1) of the waveguide portion are determined by Formula (1).

$$[ Formula 1 ]$$

$$G = ( \frac{{\sum }_{i = 1}^{n} {\sum }_{j = 1}^{m} ( D 2 ij \cdot {Δ}_{D 2 ij} )}{{\sum }_{i = 1}^{n} {\sum }_{j = 1}^{m} ( {Δ}_{D 2 ij} )} , \frac{{\sum }_{i = 1}^{n} {\sum }_{j = 1}^{m} ( D 1 ij \cdot {Δ}_{D 1 ij} )}{{\sum }_{i = 1}^{n} {\sum }_{j = 1}^{m} ( {Δ}_{D 1 ij} )} ) \qquad ( 1 )$$

When the sum of standard deviations σG in the longitudinal direction of centroid coordinates G (D2, D1) of the waveguide portion is σ [μm], σ≤0.12 is satisfied.

Further, a standard deviation ow of the roughness of the inner wall surface of the hole shape formed by dissolving the waveguide portion with an acid or an alkali is 0.12 [μm] or less. The above-mentioned “roughness of the inner wall surface” is obtained, for example, by measuring the roughness of the inner wall surface of the hole of the waveguide portion formed by dissolving the waveguide portion with an HF aqueous solution or a KOH aqueous solution by an atomic force microscope, a stylus profiling system, or the like. In the case of using a KOH aqueous solution, the roughness of the inner wall surfaces obtained after immersion in 10 vol % KOH aqueous solution for 60 minutes at 80° C. is measured. In the case of using a HF aqueous solution, the roughness of the inner wall surfaces obtained after immersion in 1 vol % HF aqueous solution for 10 minutes at room temperature is measured. It is noted that, the KOH aqueous solution is preferable to the HF aqueous solution in that the waveguide portion can be selectively dissolved and etched. The low-loss optical waveguide device 1 is obtained by adjusting the laser irradiation conditions or annealing conditions so that the measured standard deviation ow of the roughness of the inner wall surface is equal to or less than a predetermined value.

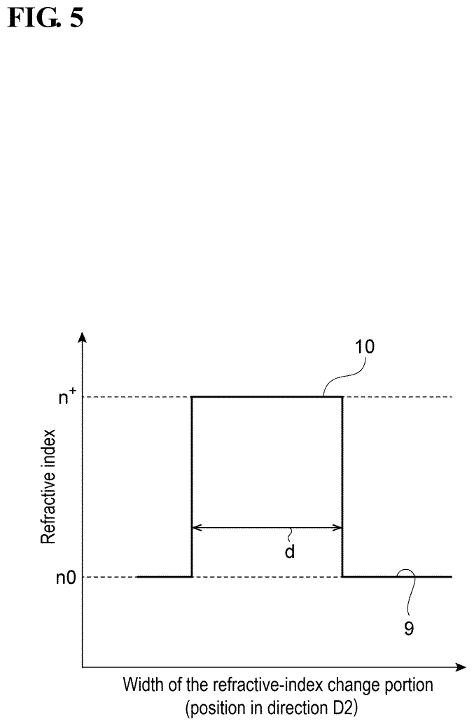

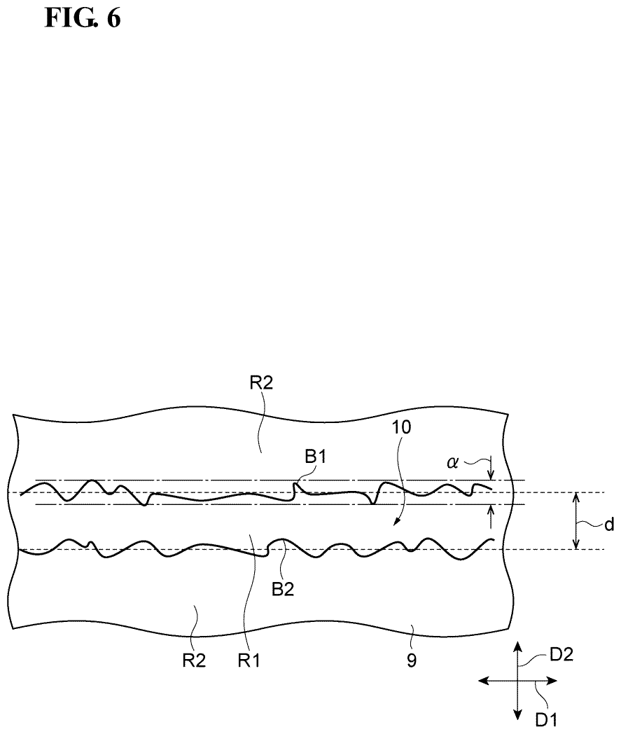

FIG. 6 shows the base portion 9 and the refractive-index change portion 10 viewed along the direction D3. The refractive-index change portion 10 is located in a region R1, and the base portion 9 is located in a region R2, the regions R2 sandwiching the region R1 in the direction D2. The refractive index of the base portion 9 is n⁻, and the maximum refractive index of the refractive-index change portion 10 is n⁺. As shown in FIG. 5 and FIG. 6, the refractive index in the refractive-index change portion 10 (the refractive-index increase portion 12) is higher than the refractive index in the cladding of the base portion 9. The waveguide diameter of the refractive-index change portion 10 varies according to the position in the direction D1. When the change amount of the positions of the outer edges B1 and B2 of the refractive-index increase portion 12 in the direction D2 is σ [μm], the value of σ is 0.12 or less. The change amount of the positions of the outer edges B1 and B2 of the refractive-index increase portion 12 in the direction D2 corresponds to the displacement amount of the positions of the outer edges B1 and B2 in the direction D2, and corresponds to the change amount of the radius of the cross section (cross section in a plane orthogonal to the direction D1) of the refractive-index change portion 10 viewed along the direction D1.

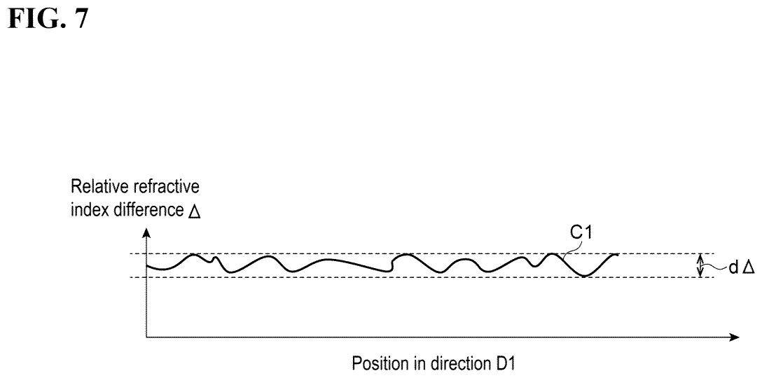

FIG. 7 is a diagram schematically showing the distribution of the refractive index of the refractive-index change portion 10 in the direction D1. The horizontal axis of the graph of FIG. 7 indicates the position in the direction D1, and the vertical axis of the graph of FIG. 7 indicates the relative refractive index difference Δ of the refractive-index change portion 10. The relative refractive index difference Δ is a ratio of a difference between a maximum refractive index n⁺ of the refractive-index change portion 10 and a refractive index n0 of the base portion 9 to the refractive index no of the base portion 9. A data C1 indicates a change in the ratio refractive index. As shown in FIG. 7, the value of the maximum refractive index n⁺ of the refractive-index change portion 10 varies according to the position in the direction D1. When the standard deviation of the relative refractive index difference Δ of the refractive-index change portion 10 in the direction D1 is dΔ [%] and the change amount of the positions of the outer edges B1 and B2 of the refractive-index increase portion 12 in the direction D2 is σ [μm], σ and dΔ satisfies formula (2) 0.1×((σ/0.13745)\hat{ }2+(dΔ/0.00677)\hat{ }2)<0.1 [dB/cm].

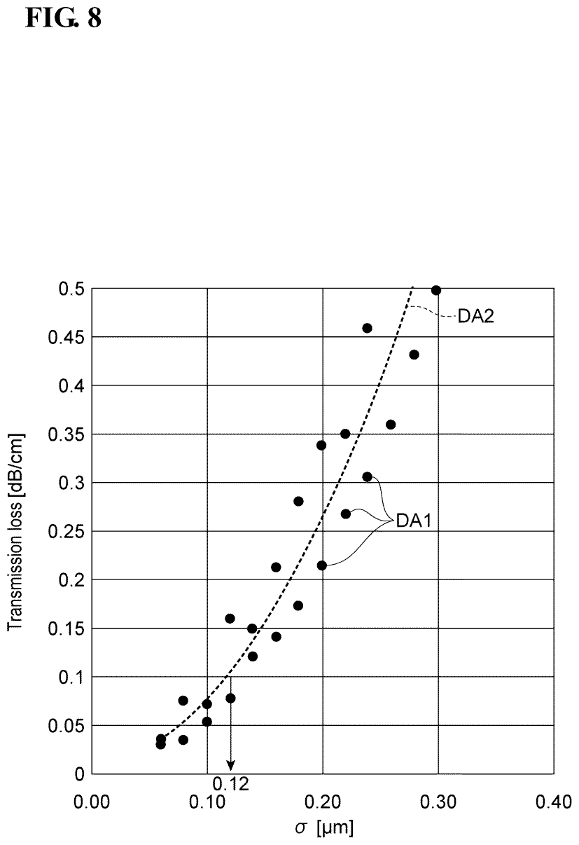

FIG. 8 is a graph showing a relationship between the change amount σ [μm] at the positions of the outer edges B1 and B2 of the refractive-index increase portion 12 in the direction D2 and the transmission loss [dB/cm] of light in the refractive-index change portion 10. A data DA1 is a plot of a plurality of samples data. A data DA2 is a polynomial approximation of the data DA1. The core ratio refractive index Δ is 0.3 to 0.4%. The change amount σ at the positions of the outer edges B1 and B2 of the refractive-index increase portion 12 is the roughness of the wall surface obtained, for example, by treating the refractive-index change portion 10 with an aqueous HF solution or an aqueous KOH solution. The roughness of the wall surface is measured by, for example, an AFM.

As shown in FIG. 8, the value of the transmission loss increases as the value of the change amount σ at the positions of the outer edges B1 and B2 of the refractive-index increase portion 12 increases. When the value of the change amount σ at the positions of the outer edges B1 and B2 of the refractive-index increase portion 12 is 0.12 or less, the transmission loss is reduced to 0.1 [dB/cm] or less. When the value of the change amount σ at the positions of the outer edges B1 and B2 of the refractive-index increase portion 12 is 0.1 or less, the transmission loss is more reliably set to 0.1 [dB/cm] or less. For example, the change amount σ is reduced by heat.

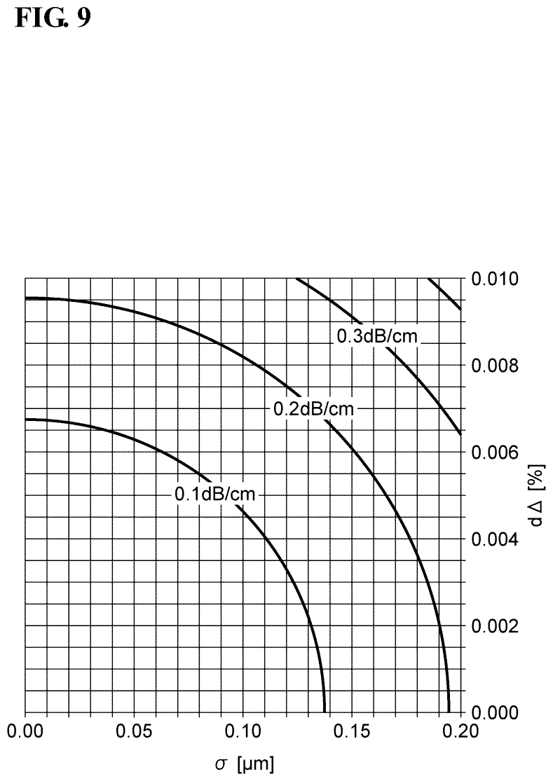

FIG. 9 is a graph showing the relationship between 0 and the standard deviation dΔ of the relative refractive index difference Δ of the refractive-index change portion 10 in the direction D1. As shown in FIG. 9, the transmission loss can be reduced as the value of dΔ and the value of σ are smaller, and when σ and dΔ satisfy the formula (2) 0.1×((σ/0.13745)\hat{ }2+(dΔ/0.00677)\hat{ }2)<0.1 [dB/cm], the transmission loss can be reduced to 0.1 [dB/cm] or less.

The region satisfying the above formula (2) can be made wider when a correlation length Lc between σ and dΔ is made shorter than 100 [μm]. The correlation length Lc may be 10 [μm] or less. FIG. 9 is a graph showing when the correlation length Lc is 10 [μm]. As an example of a method for shortening the correlation length Lc, in the first step, the femtosecond laser light Lis radiated at a plurality of periods differing from each other. That is, the femtosecond laser light Lis radiated while changing the period along the direction D1. In this case, the irradiation period of the femtosecond laser light L can be adjusted so that the correlation length Lc is shorter than 100 [μm]. For example, the femtosecond laser light L can be radiated while changing the period by modulating at least one of f and v with a random number while maintaining a repetition frequency f and a scan speed v such that the irradiation interval in each pulse of the femtosecond laser light L is 100 [nm] or less. The refractive index change in the refractive-index change portion 10 has two or more different longitudinal periods. For example, as described above, when the femtosecond laser light L is radiated, the refractive-index change portion 10 has a structure in which the formation periods of the refractive index include an f1 and an f2 which is a different formation period from the f1, with plurality of periods superimposed. For example, the refractive-index change portion 10 may have a structure in which the f1 has a period of 30 [nm] and the f2 has a period of 50 [nm]. Further, three or more periods may be superimposed, and in this case, the formation periods f1, f2, . . . , fn (n is a natural number of three or more) of the refractive-index change portion 10 are selected so as not to be integer multiples of each other.

As described above, the repetition frequency of the femtosecond laser light L in the second step is higher than 700 [KHz] and higher than the repetition frequency of the femtosecond laser light L in the first step. Thus, the transmission loss of light having a wavelength of 1310 [nm], which is a communication wavelength band, can be reduced to 0.1 [dB/cm] or less. Further, when a numerical aperture NA is 0.1 to 0.15, a single-mode operation is performed in a communication wavelength band, and a general-purpose single-mode fiber can be light-coupled with low loss. Thus, a low-loss light component in which the optical waveguide device 1 and the optical fiber are light-coupled is obtained.

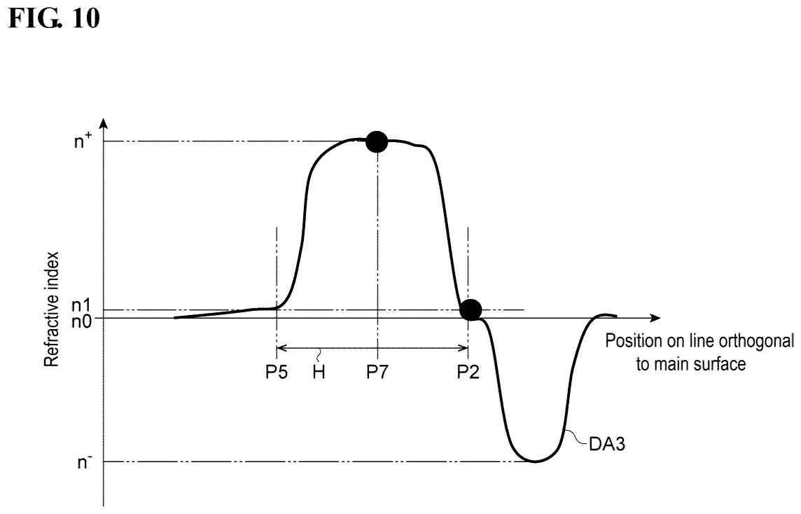

FIG. 10 is a graph indicating a refractive index change on a line passing through the refractive-index decrease portion 11 and the refractive-index increase portion 12 and orthogonal to the main surface 2d. A data DA3 is a curved line indicating a refractive index change. The horizontal axis of the graph of FIG. 10 indicates the position in the direction D3, and the vertical axis of the graph of FIG. 10 indicates the refractive index. As shown in FIG. 10, on a line passing through the refractive-index decrease portion 11 and the refractive-index increase portion 12 and orthogonal to the main surface 2d, the refractive index decreases from the refractive-index increase portion 12 toward the refractive-index decrease portion 11. An inflection point is formed between the highest point of the refractive index change in the refractive-index increase portion 12 and the lowest point of the refractive index change in the refractive-index decrease portion 11. At the highest point of the refractive index change in the refractive-index increase portion 12, the refractive index is n⁺. At the lowest point of the refractive index change in the refractive-index decrease portion 11, the refractive index is n⁻.

The boundary P2 between the refractive-index decrease portion 11 and the refractive-index increase portion 12 includes an inflection point of a curved line indicating a refractive index change on a line passing through the refractive-index decrease portion 11 and the refractive-index increase portion 12 and orthogonal to the main surface 2d. In the boundary P2, the refractive index is n1. The boundary P2 is one end of the refractive-index increase portion 12 in the direction D3, and a position P5 is the other end of the refractive-index increase portion 12 in the direction D3. Thus, a width H from the boundary P2 to the position P5 is the width of the refractive-index increase portion 12 in the direction D3.

For example, a value obtained by dividing the width of the refractive-index increase portion 12 in the direction D3 by the maximum width of light propagating through the refractive-index increase portion 12 is 0.6 to 2. A value obtained by dividing the width of the refractive-index increase portion 12 in the direction D3 by the maximum width of light propagating through the refractive-index increase portion 12 may be 1.0 to 1.5. The maximum width of the light propagating through the refractive-index increase portion 12 is, for example, the diameter of the light propagating through the refractive-index increase portion 12. In other words, the maximum width of light propagating through the refractive-index increase portion 12 is the mode field diameter (MFD) of light propagating through the refractive-index increase portion 12. The wavelength of light propagating through the refractive-index increase portion 12 is 850 nm to 1650 nm.

A value obtained by dividing a distance d from the boundary P2 between the refractive-index decrease portion 11 and the refractive-index increase portion 12 to a portion P7 in which intensity of propagating light is at its maximum in the refractive-index increase portion 12 by a maximum width of light propagating through the refractive-index increase portion 12 is 0.5 or more. A value obtained by dividing the distance d from the boundary P2 between the refractive-index decrease portion 11 and the refractive-index increase portion 12 to the portion P7 in which intensity of propagating light is at its maximum in the refractive-index increase portion 12 by a maximum width of light propagating through the refractive-index increase portion 12 may be 0.7 or more.

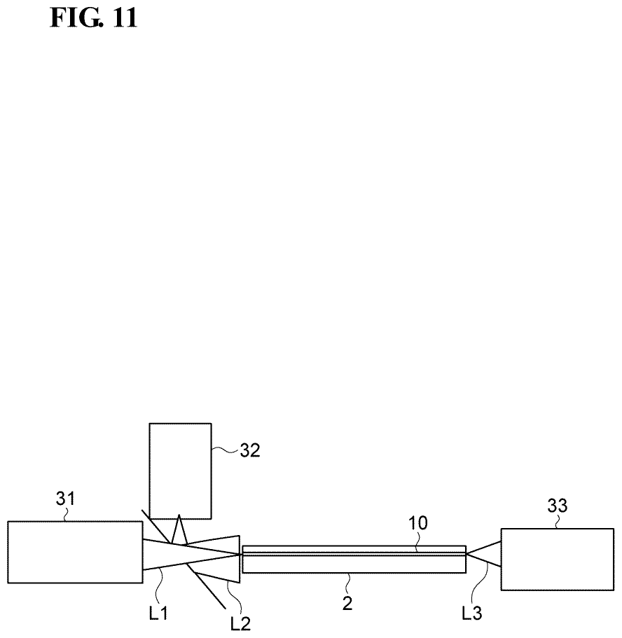

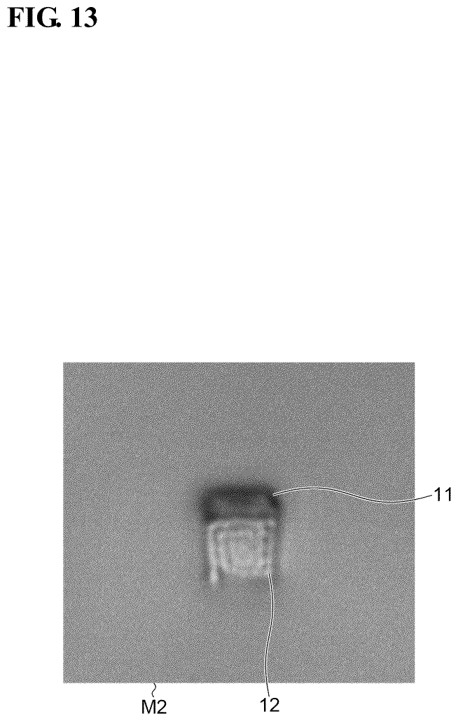

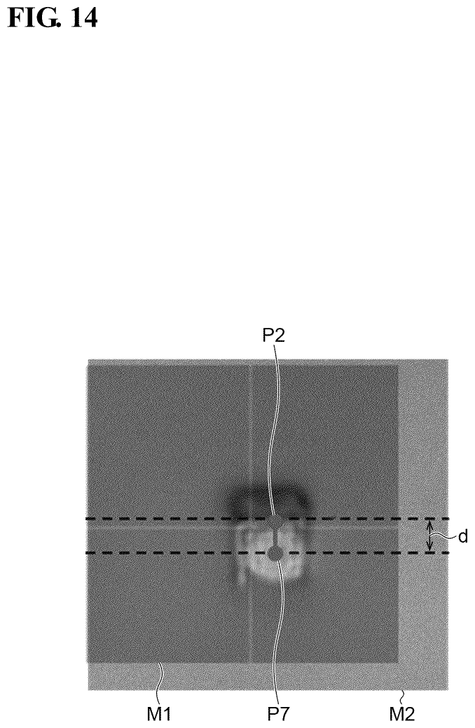

The distance d between the boundary P2 between the refractive-index decrease portion 11 and the refractive-index increase portion 12 and the portion P7 of the refractive-index increase portion 12 in which intensity of propagating light is at its maximum is 5 μm or more. The distance d between the boundary P2 between the refractive-index decrease portion 11 and the refractive-index increase portion 12 and the portion P7 of the refractive-index increase portion 12 in which intensity of propagating light is at its maximum may be 7 μm or more. FIG. 11 is a schematic view showing a light optical system for observing the portion P7 in which intensity of propagating light is at its maximum in the refractive-index increase portion 12. FIG. 13 is a diagram showing an image M2 including the refractive-index change portion 10 formed on the glass substrate. FIG. 14 is a diagram showing an image obtained by superimposing an image M1 including a portion wherein which intensity of propagating light is at its maximum in the refractive-index increase portion 12 and the image M2 including a refractive-index change portion formed on a glass substrate.

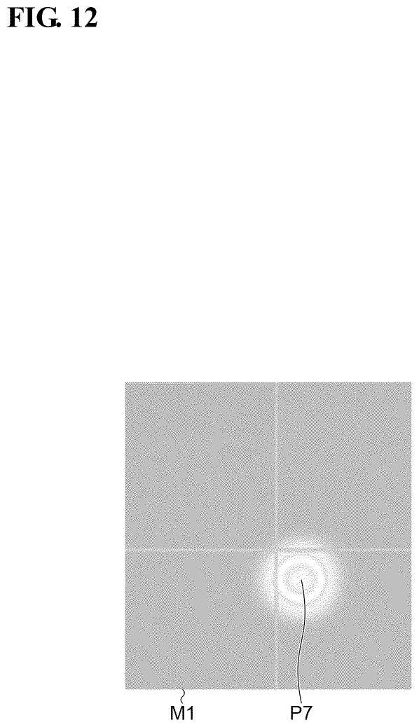

For example, as shown in FIG. 11, a near-infrared light source 31, a wideband light source 32, and a camera 33 are used to observe the portion P7. The near-infrared light source 31 radiates near-infrared rays onto the optical waveguide including the refractive-index change portion 10 of the substrate 2. For example, the near-infrared light source 31 irradiates the substrate 2 with a near-infrared ray L1 of a wavelength 1310 nm. The near-infrared ray radiated from the optical waveguide of the substrate 2 is incident on the camera 33. The camera 33 captures a near field pattern (NFP) and acquires the image M1. As shown in FIG. 12, the image M1 includes the portion P7 in which intensity of propagating light is at its maximum in the refractive-index increase portion 12.

The wideband light source 32 irradiates the refractive-index change portion 10 of the substrate 2 with a wideband light L2. For example, the wideband light source 32 is a halogen lamp. The light radiated from the substrate 2 is incident on the camera 33 as light L3 together with the near-infrared ray radiated from the optical waveguide of the substrate 2. The camera 33 captures the NFP and acquires the image M2. As shown in FIG. 13, the image M2 includes the refractive-index change portion 10 formed on the glass substrate, and includes the boundary P2 between the refractive-index decrease portion 11 and the refractive-index increase portion 12.

By superimposing the image M1 and the image M2, as shown in FIG. 14, the distance d between the boundary P2 between the refractive-index decrease portion 11 and the refractive-index increase portion 12 and the portion P7 in which intensity of propagating light is at its maximum in the refractive-index increase portion 12 is observed. The image M1 and the image M2 are superimposed such that the coordinates of the real space indicated by each image coincide with each other.

Next, an optical waveguide device in a modification of the embodiment will be described. The modifications are generally similar or identical to the embodiments described above. Hereinafter, differences between the above-described embodiment and modifications will be mainly described. In the optical waveguide device 1, the substrate 2 may include the plurality of refractive-index change portions 10 that are spaced apart from each other and extend along the main surface 2d. In other words, the substrate 2 may include a plurality of waveguides spaced apart from each other. In this case, for example, in the substrate 2, a plurality of cores in each of which the relative refractive index difference of the refractive-index increase portion 12 is 0.2% or more are formed by each of the plurality of refractive-index change portions 10. When the distance between the pluralities of cores is 20 μm to 40 μm and propagating light in the plurality of refractive-index change portions has a wavelength of 1310 nm to 1550 nm, crosstalk between the plurality of refractive-index change portion is-30 dB or less.

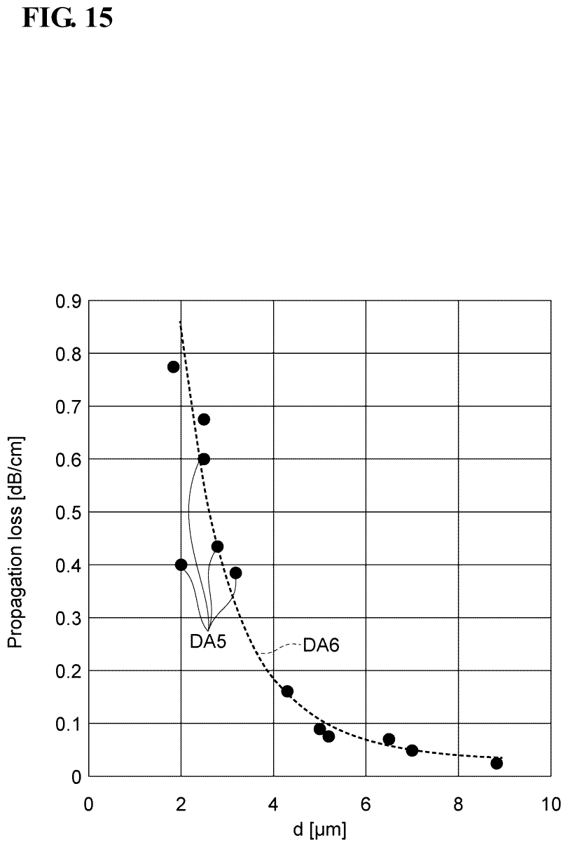

Next, the effects of the optical waveguide device 1 will be described with reference to FIG. 15. FIG. 15 is a graph showing the transmission loss [dB/cm] of light with respect to the distance d [μm] between the boundary P2 between the refractive-index decrease portion 11 and the refractive-index increase portion 12 and the portion P7 in which intensity of propagating light is at its maximum in the refractive-index increase portion 12. A data DA5 is a plot of a plurality of samples data. A data DA6 is a polynomial approximation of the data DA5. As shown in FIG. 15, the value of the transmission loss decreases as the distance d increases. It was confirmed that the transmission loss was reduced to 0.1 [dB/cm] or less when the distance d was 5 μm or more. It was found that the transmission loss was further reduced when the distance d was 7 μm or more.

In the optical waveguide device 1 of the example shown in the embodiment, the distance d between the boundary P2 between the refractive-index decrease portion 11 and the refractive-index increase portion 12 and the portion P7 in which intensity of propagating light is at its maximum in the refractive-index increase portion 12 is 5 μm or more. Thus, optical loss is reduced in a configuration in which the refractive-index change portion is formed in the glass substrate.

In the optical waveguide device 1, a value obtained by dividing the distance d by the maximum width of light propagating through the refractive-index increase portion 12 may be 0.5 or more. The degree of confinement of the propagating light in the refractive-index increase portion 12 is also considered to be related to the optical loss. According to this configuration, the optical loss is more reliably reduced.

In the optical waveguide device 1, the substrate 2 may contain 10 wt % or more of silicon dioxide (SiO₂). In this case, the bandgap in the base portion 9 may be 3.5 eV or more. In this case, a structure in which the refractive-index decrease portion 11 is more precisely formed, is provided. In the glass containing a certain amount or more of SiO₂, the glass transition temperature is generally 700° C. or higher, and the melting range is limited to submicron or less even after the energy of laser light is converted into heat through electron-phonon relaxation. Thus, the reduction of light scattering and the formation of the optical waveguide by the refractive-index decrease portion 11 are more precisely controlled. The weight percent concentration of silicon dioxide can be measured by an electron probe micro analyzer or the like. The bandgap can be measured by an ultraviolet-visible light method.

In the optical waveguide device 1, the boundary P2 between the refractive-index decrease portion 11 and the refractive-index increase portion 12 may include an inflection point of a curved line indicating a refractive index change on a line passing through the refractive-index decrease portion 11 and the refractive-index increase portion 12 and orthogonal to the main surface 2d. In this case, the optical loss is further reduced.

In the optical waveguide device 1, a value obtained by dividing the width of the refractive-index increase portion 12 in the direction D3 orthogonal to the main surface 2d by the maximum width of light propagating through the refractive-index increase portion 12 may be 0.6 to 2. The longer the width of the refractive-index increase portion 12 in the direction D3 orthogonal to the main surface 2d, the longer the distance d is likely to be constituted. When the width of the refractive-index increase portion 12 in the direction D3 orthogonal to the main surface 2d is too long, a high-order mode may occur. According to the above configuration, the width of the refractive-index increase portion 12 in the direction D3 orthogonal to the main surface 2d is balanced, and the optical loss is further reduced.

When the optical waveguide is formed by the plurality of refractive-index change portions 10, the position of the outer edge of the refractive-index change portion 10 is likely to change. In this case, light scattering is considered to be likely to occur. In the optical waveguide device 1, the change amount of the position of the outer edge of the refractive-index increase portion 12 in the direction D2 may be 0.12 μm or less. When the change amount of the position of the outer edge of the refractive-index increase portion 12 in the direction D2 is large, the scattering loss may increase. According to the above configuration, the optical loss is further reduced.

When the optical waveguide is formed by the plurality of refractive-index change portions 10, the perturbation of the relative refractive index difference is likely to occur. In this case, light scattering is considered to be likely to occur. In the optical waveguide device 1, when a change amount of the position of the outer edge of the refractive-index increase portion 12 in the direction D2 is σ [μm] and a change amount of the relative refractive index difference of the refractive-index increase portion in the direction D1 is dΔ [%], 0.1×((σ/0.13745)\hat{ }2+(dΔ/0.00677)\hat{ }2)<0.1 [dB/cm] may be satisfied. In this case, the optical loss is further reduced. The unit of the coefficient of each constant is 0.13745 [(μm·cm/dB)^{1/2}] or 0.00677 [(%·cm/dB)^{1/2}].

In the optical waveguide device 1, the substrate 2 may include the plurality of refractive-index change portions 10 that are spaced apart from each other and extend along the main surface 2d. In the substrate 2, a plurality of cores in each of which the relative refractive index difference of the refractive-index increase portion 12 is 0.2% or more may be formed by each of the plurality of refractive-index change portions 10. When the distance between the plurality of cores is 20 μm to 40 μm and propagating light in the plurality of refractive-index change portions has a wavelength of 1310 nm to 1550 nm, crosstalk between the plurality of refractive-index change portions may be −30 dB or less. In this case, an optical waveguide that reduces optical loss and operates in a single mode is created. When the distance between the pluralities of cores is 40 μm or less, the crosstalk between the cores is reduced, and the optical loss is reduced. When the distance between the plurality of cores is 20 μm or more and the relative refractive index difference of the refractive-index increase portion 12 is 0.2% or more, the crosstalk between the cores is further reduced and the optical loss is reduced. The inter-core crosstalk can be measured by making laser light incident on a specific core and measuring the received light power of the laser light output from another core.

Although the embodiments of the present disclosure have been described in detail, the present disclosure is not limited to the above-described embodiments, and can be applied to various embodiments. For example, in the above-described embodiment, an example in which the irradiation with the femtosecond laser light L is performed once in the second step has been described. However, the number of times of irradiation with the femtosecond laser light L in the second step may be plural times, and is not particularly limited. In the above-described embodiment, the substrate 2 constituted by a single layer, but the substrate 2 may be constituted by a plurality of layers having different compositions or different composition ratios. That is, the substrate 2 may be a multilayer substrate. In this case, for example, the waveguide of the substrate 2 may be formed in one layer of the plurality of layers.

### REFERENCE SIGNS LIST

1 optical waveguide device
2 substrate
2b first end surface
2c second end surface
2d main surface
9 base portion
10 refractive-index change portion
11 refractive-index decrease portion
12 refractive-index increase portion
15 reducing portion
31 near-infrared light source
32 wideband light source
33 camera
B1 outer edge
B2 outer edge
C1 data
d distance
D1 direction
D2 direction
D3 direction
DA5 data
DA6 data
dΔ standard deviation
f repetition frequency
f1 formation period
f2 formation period
G centroid coordinates
H width
L femtosecond laser light
L1 near-infrared ray
L2 light
L3 light
Lc correlation length
M irradiation device
M1 image
M2 image
n⁺ refractive index
n⁻ refractive index
n0 refractive index
n1 refractive index
NA numerical aperture
P1 light convergence position
P2 boundary
P3 light convergence position
P7 portion
R1 region
R2 region
v scan speed
α direction
Δ relative refractive index difference
σG standard deviation
σw standard deviation

1. An optical waveguide device comprising:
a substrate constituted by glass having a uniform composition ratio,
wherein the substrate includes a base portion and a refractive-index change portion having a refractive index differing from a refractive index of the base portion,
wherein the refractive-index change portion includes at least a pair of a refractive-index decrease portion and a refractive-index increase portion,
wherein a refractive index of the refractive-index increase portion is higher than a refractive index of the refractive-index decrease portion, and
wherein a distance from a boundary between the refractive-index decrease portion and the refractive-index increase portion to a portion in which intensity of propagating light is at its maximum in the refractive-index increase portion is 5 μm or more.

2. The optical waveguide device according to claim 1,
wherein a value obtained by dividing the distance by a maximum width of light propagating through the refractive-index increase portion is 0.5 or more.

3. The optical waveguide device according to claim 1,
wherein the substrate contains 10 wt % or more of silicon dioxide, and
wherein a bandgap in the base portion is 3.5 eV or more.

4. An optical waveguide device comprising:
a substrate constituted by glass having a uniform composition ratio,
wherein the substrate includes a base portion and a refractive-index change portion having a refractive index differing from a refractive index of the base portion,
wherein the refractive-index change portion includes at least a pair of a refractive-index decrease portion and a refractive-index increase portion,
wherein a refractive index of the refractive-index increase portion is higher than a refractive index of the refractive-index decrease portion, and
wherein a value obtained by dividing a distance from a boundary between the refractive-index decrease portion and the refractive-index increase portion to a portion in which intensity of propagating light is at its maximum in the refractive-index increase portion by a maximum width of light propagating through the refractive-index increase portion is 0.5 or more.

5. The optical waveguide device according to claim 4,
wherein the substrate contains 10 wt % or more of silicon dioxide, and
wherein a bandgap in the base portion is 3.5 eV or more.

6. The optical waveguide device according to claim 1,
wherein the substrate has a main surface,
wherein, in the pair of the refractive-index decrease portion and the refractive-index increase portion, the refractive-index decrease portion is located between a portion of the refractive-index increase portion and the main surface, and
wherein the boundary between the refractive-index decrease portion and the refractive-index increase portion includes an inflection point of a curved line indicating a refractive index change on a line passing through the refractive-index decrease portion and the refractive-index increase portion and orthogonal to the main surface.

7. The optical waveguide device according to claim 1,
wherein the substrate has a main surface,
wherein, in the pair of the refractive-index decrease portion and the refractive-index increase portion, the refractive-index decrease portion is located between a portion of the refractive-index increase portion and the main surface, and
wherein a value obtained by dividing a width of the refractive-index increase portion in a direction orthogonal to the main surface by a maximum width of light propagating through the refractive-index increase portion is 0.6 to 2.

8. The optical waveguide device according to claim 1,
wherein the substrate has a main surface,
wherein, in the pair of the refractive-index decrease portion and the refractive-index increase portion, the refractive-index decrease portion is located between a portion of the refractive-index increase portion and the main surface,
wherein the refractive-index change portion extends in a first direction along the main surface, and
wherein a change amount of a position of an outer edge of the refractive-index increase portion in a second direction along the main surface and orthogonal to the first direction is 0.12 μm or less.

9. The optical waveguide device according to claim 1,
wherein the substrate has a main surface,
wherein, in the pair of the refractive-index decrease portion and the refractive-index increase portion, the refractive-index decrease portion is located between a portion of the refractive-index increase portion and the main surface,
wherein the refractive-index change portion extends in a first direction along the main surface, and
wherein, when a change amount of a position of an outer edge of the refractive-index increase portion in a second direction along the main surface and orthogonal to the first direction is σ [μm], and a change amount of a relative refractive index difference of the refractive-index increase portion in the first direction is dΔ [%],
$$0.1 \times ( {( σ / 0.13745 )}^{∧} 2 + {( d Δ / 0.00677 )}^{∧} 2 ) < 0.1 [ dB / cm ]$$
is satisfied.

10. The optical waveguide device according to claim 1,
wherein the substrate has a main surface,
wherein, in the pair of the refractive-index decrease portion and the refractive-index increase portion, the refractive-index decrease portion is located between a portion of the refractive-index increase portion and the main surface,
wherein the substrate includes a plurality of the refractive-index change portions spaced apart from each other and extending along the main surface,
wherein a plurality of cores in each of which a relative refractive index difference of the refractive-index increase portion is 0.2% or more are formed in the substrate by each of the plurality of refractive-index change portions, and
wherein, when a distance between the plurality of cores is 20 μm to 40 μm and propagating light in the plurality of refractive-index change portions has a wavelength of 1310 nm to 1550 nm, crosstalk between the plurality of refractive-index change portions is −30 dB or less.
